(19) United States
(12) Patent Application Publication
(10) Pub. No.: US 2013/0128240 A1
(43) Pub. Date: May 23, 2013

(54) PROJECTOR AND METHOD OF CONTROLLING THE SAME

(71) Applicant: Seiko Epson Corporation, Tokyo (JP)

(72) Inventors: Shingo Yoshida, Matsumoto-shi (JP); Shuichi Fujiwara, Azumino-shi (JP); Yasuhiro Honda, Shiojiri-shi (JP)

(73) Assignee: SEIKO EPSON CORPORATION, Tokyo (JP)

(21) Appl. No.: 13/675,201

(22) Filed: Nov. 13, 2012

(30) Foreign Application Priority Data
Nov. 17, 2011 (JP) 2011-251341

(51) Int. Cl. G03B 21/14; G03B 21/28

(52) U.S. Cl. CPC G03B 21/14; G03B 21/28
USPC 353/85; 353/98; 353/121

(57) ABSTRACT

A projector, adapted to project image light while making the image light wide-angle with a reflecting section to thereby display an image, includes a detection section adapted to detect an obstacle, which blocks the image light reflected by the reflecting section, a message display section adapted to display a warning message within the image if the detection section detects the obstacle, and a display position change section adapted to change a display position of the warning message within the image in accordance with passage of time.

The entire disclosure of Japanese Patent Application No. 2011-251341, filed Nov. 17, 2011 is expressly incorporated by reference herein.

### BACKGROUND

1. Technical Field

The present invention relates to a projector for projecting image light and a method of controlling the projector.

2. Related Art

When using a projector for projecting the image light, if an obstacle enters the vicinity of the projector so as to block the image light, the obstacle is irradiated with the light to thereby be apt to be heated to high temperature, and therefore, plenty of attention needs to be paid thereto. Therefore, in JP-A-2007-34318 there is proposed a projector provided with a sensor for detecting an obstacle (a foreign matter) having entered an opening section of a housing through which the image light passes. The projector is arranged to be able to perform warning display by the onscreen display (OSD) when detecting the obstacle described above.

However, in the circumstances in which the projection of the image is partially blocked by the obstacle, even if the warning display is performed, apart of the warning display may be difficult to visually recognize in some cases. As a result, it is also possible that the user fails to be informed of the content of the warning, and an appropriate response is delayed. In particular, in the close projection type of projector for projecting the image light while expanding it with a concave mirror, since the image light reflected by the concave mirror is converged at a predetermined position and is then diffused, if the obstacle enters the vicinity of the position at which the image light is converged, the temperature of the obstacle is apt to rise rapidly, and a prompt response is required.

### SUMMARY

An advantage of some aspects of the invention is to solve at least a part of the problems described above, and the invention can be implemented as the following forms or application examples.

This application example is directed to a projector adapted to project image light while making the image light wide-angle with a reflecting section to thereby display an image, including a detection section adapted to detect an obstacle, which blocks the image light reflected by the reflecting section, a message display section adapted to display a warning message within the image if the detection section detects the obstacle, and a display position change section adapted to change a display position of the warning message within the image in accordance with passage of time.

According to the projector, since the display position change section changes the display position of the warning message displayed if the obstacle is detected in accordance with the passage of time, even in the case in which the image to be projected is partially hidden by the obstacle, the display position is changed, and therefore, the warning message can visually be recognized.

The warning message may be displayed if the detection of the obstacle by the detection section has continued for a period equal to or longer than the first predetermined time, thereby there is no chance that the warning message is displayed due to the obstacle temporarily (shorter than the first predetermined time) entering the area.

The luminance of the image light may be decreased if the detection section detects the obstacle, thereby the rise in temperature of the obstacle can be suppressed.

The projection of the image light may be stopped if the detection of the obstacle has continued for a second predetermined time since the warning message has been displayed, thereby it is possible to prevent the obstacle from continuing to be irradiated with the image light.

The image in which the warning message is displayed may be set to black, thereby the irradiation of light to the obstacle, namely the rise in temperature of the obstacle when displaying the warning message can be suppressed.

At least one of switching of the state indication section for indicating the operation state of the projector and the generation of the warning tone may be started if the detection section detects the obstacle, thereby it is possible to more reliably notify the user of the fact that the projector is in the state in which the obstacle is detected.

The opening section for guiding the image light to the outside may be provided to the housing, and the detection section may detect the obstacle blocking the opening section, if the projector is installed so that the opening section faces upward, and the obstacle is mounted on the housing so as to partially cover the opening section, thereby the obstacle can easily be detected.

### BRIEF DESCRIPTION OF THE DRAWINGS

The invention will be described with reference to the accompanying drawings, wherein like numbers reference like elements.

FIGS. 1A and 1B are diagrams showing a projector according to an embodiment of the invention, wherein FIG. 1A is a perspective view, and FIG. 1B is a side view showing an internal configuration of the projector.

FIG. 2 is a block diagram showing a schematic configuration of the projector according to the embodiment.

FIG. 3 is a flowchart for explaining the operation of the projector according to the embodiment in the power-ON state.

FIG. 4 is a diagram showing a message image.

FIG. 5 is an explanatory diagram for explaining the change in the display position of the message image.

### DESCRIPTION OF AN EXEMPLARY EMBODIMENT

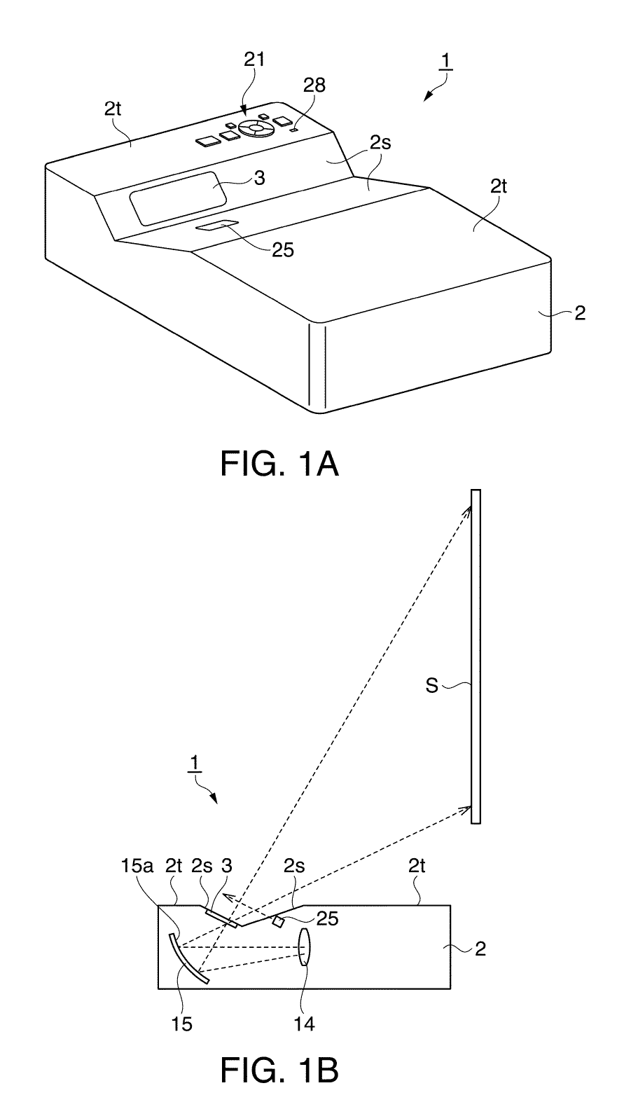

Hereinafter, a projector for projecting image light will be explained with reference to the accompanying drawings. As shown in FIGS. 1A and 1B, the projector 1 is configured including a housing 2 for housing a device main body, and on the upper surface 2t of the housing 2 there are disposed an input operation section 21 on which an input operation is performed by the user, and alight emitting diode (LED) display section 28 for displaying the operating state and so on of the projector 1. Further, the upper surface 2t of the housing 2 is provided with a tilted section 2s recessed to have a V-shaped side view, and on the tilted section 2s, there are disposed a projection window 3 and an obstacle sensor 25 as a detection section. The projection window 3 is a region obtained by blocking the opening section provided to the housing 2 with a member (e.g., glass) having a light transmissive property and a heat resistance property, and guides the image light from the inside of the housing 2 to the outside thereof. The obstacle sensor 25 is capable of detecting the obstacle, which enters the vicinity of the projection window 3 and blocks the image light.

As shown in FIG. 1B, the projector 1 is a close projection projector for projecting the image light on a projection surface S (e.g., a screen) with a relatively short distance therefrom, and is disposed in the lower vicinity of the projection surface S. The projector 1 is supplied with the image information from an external image supply device not shown, and then projects the image light based on the image information in response thereto to thereby display a projection image on the projection surface S. A personal computer (PC), a USB memory, or the like corresponds to the external image supply device. Inside the housing 2, there are housed a lens 14 for projecting the image light, and a concave mirror 15 as a reflecting section for making the image light to be projected wide-angle. The concave mirror 15 has a reflecting surface 15a having a concave and aspheric shape, and the reflecting surface 15a is disposed so as to be opposed to the projection surface S. Further, inside the housing 2, the image light, which has been obtained by modulating the light from a light source using a modulation element such as a liquid crystal light valve described later, is emitted toward the reflecting surface 15a of the concave mirror 15, and the image light reflected by the concave mirror 15 is emitted to the outside of the housing 2 through the projection window 3. In this case, the image light converges in the vicinity of the projection window 3, and then reaches the projection surface S in a diffused state.

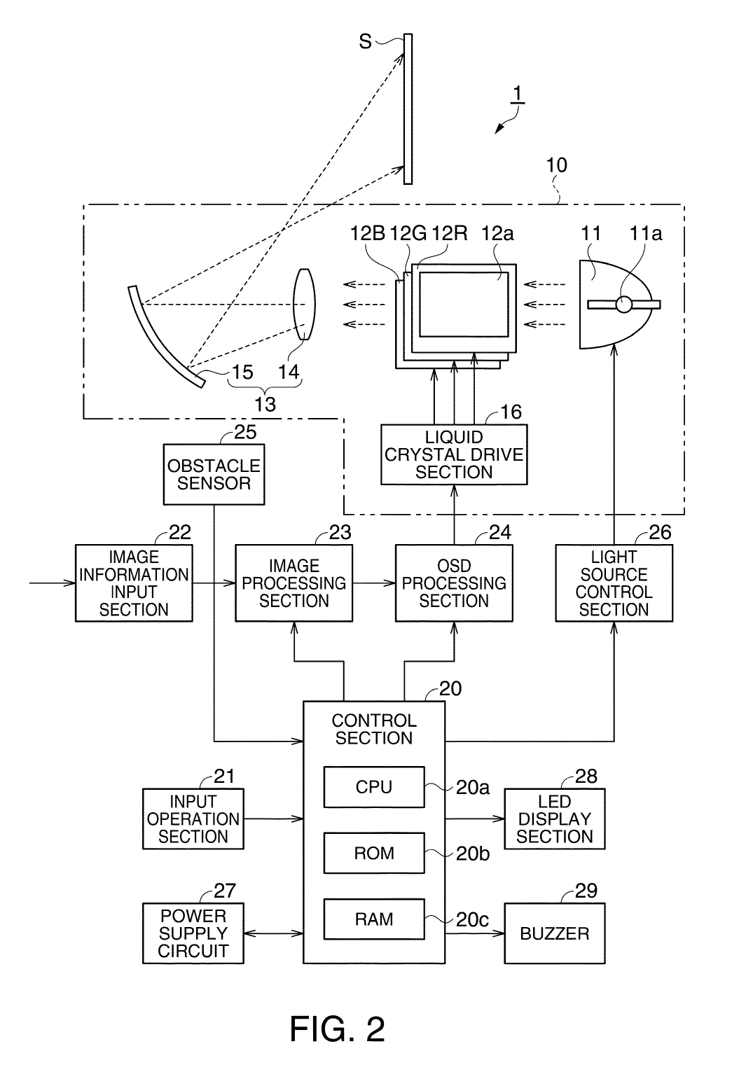

As shown in FIG. 2, the projector 1 is provided with an image projection section 10, a control section 20, an input operation section 21, an image information input section 22, an image processing section 23, an OSD processing section 24, an obstacle sensor 25, a light source control section 26, a power supply circuit 27, an LED display section 28, and a buzzer 29, and so on.

The image projection section 10 is composed mainly of a light source device 11 as the light source, three liquid crystal light valves 12R, 12G, and 12B as the light modulation device, a projection optical system 13, and a liquid crystal drive section 16. The image projection section 10 modulates the light emitted from the light source device 11 into the image light with the liquid crystal light valves 12R, 12G, and 12B, and then projects the image light by the projection optical system 13 to thereby display it on the projection surface S.

The light source device 11 is configured including a discharge light source lamp 11a formed of, for example, a super-high pressure mercury lamp or a metal halide lamp. The light emitted from the light source device 11 is converted into light having a substantially even intensity distribution by an integrator optical system not shown, and is separated into colored light components of red (R), green (G), and blue (B), the three primary colors of light, by a color separation optical system not shown, and then the colored light components enter the liquid crystal light valves 12R, 12G, and 12B, respectively.

The liquid crystal light valves 12R, 12G, and 12B are each composed mainly of a transmissive liquid crystal panel having a liquid crystal material encapsulated between a pair of transparent substrates. The liquid crystal light valves 12R, 12G, and 12B are each provided with a pixel area 12a having a rectangular shape with a plurality of pixels (not shown) arranged in a matrix, and arranged so as to be able to apply a drive voltage to the liquid crystal material pixel by pixel. When the liquid crystal drive section 16 applies the drive voltage corresponding to the image information input thereto to each of the pixels, each of the pixels is set to have a light transmission corresponding to the image information. Therefore, the light emitted from the light source device 11 is modulated while being transmitted through the pixel area 12a of each of the liquid crystal light valves 12R, 12G, and 12B, and thus the image light corresponding to the image information is formed for each of the colored lights. The image lights of the respective colors are combined pixel-by-pixel by a color combining optical system not shown, and are formed as a color image light.

The projection optical system 13 is configured including the lens 14 and the concave mirror 15, and projects the image light modulated by the liquid crystal light valves 12R, 12G, and 12B on the projection surface S while making the image light wide-angle with the concave mirror 15.

The control section 20 is provided with a central processing unit (CPU) 20a, a nonvolatile read only memory (ROM) 20b storing a control program, setting data, and so on, and a random access memory (RAM) 20c used as a temporary storage of various processes, and controls the operation of the projector 1 by the CPU 20a executing the control program stored in the ROM 20b to thereby perform an arithmetic processing while temporarily storing necessary information in the RAM 20c. In other words, the control section 20 functions as a computer.

The input operation section 21 is for receiving an input operation of the user, and is provided with a plurality of operation keys for the user to provide various instructions to the projector 1. When the user operates the various operation keys of the input operation section 21, the input operation section 21 receives the operation and then outputs a control signal corresponding to the operation key thus operated to the control section 20. Then, when the control signal is input from the input operation section 21, the control section 20 performs the process based on the control signal thus input to thereby control the operation of the projector 1. It should be noted that it is also possible to adopt a configuration of using a remote controller (not shown) capable of a remote operation as the input operation section 21. In this case, the remote controller transmits an operation signal on an infrared ray corresponding to the content of the operation by the user, and then a receiving section not shown receives the operation signal and then transmits it to the control section 20.

The image information input section 22 is provided with a plurality of input terminals, and a variety of types of image information are input to these input terminals from an external image supply device not shown such as a video playback device or a personal computer. The image information input section 22 outputs the image information to the image processing section 23.

The image processing section 23 converts the image information input from the image information input section 22 into the image information representing the grayscales of the respective pixels of the liquid crystal light valves 12R, 12G, and 12B, namely the image information for defining the drive voltages applied to the respective pixels. Here, the image information obtained by the conversion includes a plurality of pixels values corresponding to the respective pixels of the liquid crystal light valves 12R, 12G, and 12B. The pixel value is for determining the light transmission rate of the corresponding pixel, and defines the luminance of the light emitted from the pixel. Further, the image processing section 23 performs, for example, an image quality adjustment process for adjusting the image quality such as the brightness, the contrast, the sharpness, and the color on the image information thus converted, and then outputs the image information thus processed to the OSD processing section 24 based on the instruction of the control section 20.

Further, the image processing section 23 can perform a process of setting all of the pixel values to the minimum value (0) so that the light transmission rates of all of the pixels are minimized based on the instruction of the control section 20. In this case, the image information with all of the pixel values set to 0, namely the image information representing a solid black image (a black image), is output to the OSD processing section 24, and then the black image is projected from the image projection section 10. As described above, the image processing section 23 can switch between the state of projecting the image (input image) based on the image information input to the image information input section 22 and the state of projecting the black image in accordance with the instruction of the control section 20.

Based on the instruction of the control section 20, the OSD processing section 24 performs processing for displaying an on-screen display (OSD) image such as a menu image or a message image superimposed on the image based on the image information input from the image processing section 23. The OSD processing section 24 is provided with an OSD memory not shown, and stores the OSD image information representing figures, fonts, and so on for forming the OSD image. When the control section 20 instructs the superimposition of the OSD image, the OSD processing section 24 reads out the necessary OSD image information from the OSD memory, and then combines the OSD image information with the image information input from the image processing section 23 so that the OSD image is superimposed at a predetermined position on the image. The image information combined with the OSD image information is then output to the liquid crystal drive section 16. It should be noted that in absence of the instruction from the control section 20 to superimpose the OSD image, the OSD processing section 24 outputs the image information input from the image processing section 23 directly to the liquid crystal drive section 16.

Subsequently, when the liquid crystal drive section 16 drives the liquid crystal light valves 12R, 12G, and 12B in accordance with the image information input from the OSD processing section 24, the light emitted from the light source device 11 is modulated by the liquid crystal light valves 12R, 12G, and 12B into the image light corresponding to the image information, and is then projected from the projection optical system 13.

The obstacle sensor 25 is configured including, for example, a light emitting device (e.g., an LED) for emitting an infrared beam, and a light receiving device (e.g., a photodiode) for receiving the infrared beam, and detects the obstacle having entered the vicinity of the projection window 3 and then outputs the detection result to the control section 20. Specifically, the obstacle sensor 25 detects the obstacle, which blocks at least a part of the projection window 3 (an opening section) and blocks the image light.

The light source control section 26 controls lighting of the light source device 11 (the light source lamp 11a) based on the instruction of the control section 20. Specifically, the light source control section 26 is capable of supplying the light source lamp 11a with predetermined electrical power to thereby light the light source lamp 11a, and stopping the supply of the electrical power to thereby put off the light source lamp 11a. Further, the light source control section 26 also functions as a luminance control section, and is capable of controlling the luminance (brightness) of the light source lamp 11a by controlling the electric power supplied to the light source lamp 11a based on the instruction of the control section 20. In the present embodiment, it is arranged that the luminance can be changed to two levels, namely a “high luminance” level in which the light source lamp 11a is relatively bright and a “low luminance” level in which the light source lamp 11a is relatively dark.

The power supply circuit 27 is externally supplied with the commercial power. The power supply circuit 27 converts the commercial power (alternating-current power) into direct-current power with a predetermined voltage, and supplies each section of the projector 1 with the electrical power (the supply path to each section will be omitted from the drawing). Further, in accordance with the instruction of the control section 20, the power supply circuit 27 can switch between the state (the power-on state) of supplying each section with the power (the operation power) necessary for the projection of the image and the state (the stand-by state) of halting the supply of the operation power and standing ready and waiting for the operation for switching the power on.

The LED display section 28 is an indicator provided with an LED, and switches the display state (e.g., lighting, blinking, extinction, and the emission color) thereof based on the instruction of the control section 20 to thereby inform the user of the operation state (e.g., powering-on, powering-off, and occurrence of an error) of the projector 1. It should be noted that the LED display section 28 corresponds to a state indication section.

The buzzer 29 is formed of, for example, a piezoelectric buzzer, and generates a warning tone (beep sound) based on the instruction of the control section 20. It should be noted that the buzzer 29 corresponds to a warning tone generation section.

Then, the operation of the projector 1 will be explained.

When the projector 1 is supplied with the commercial power, the power supply circuit 27 supplies at least the control section 20, the input operation section 21, and the LED display section 28 with the stand-by power, and then the control section 20 starts the operation with the control program in response to the power supply. Immediately after the commercial power has been supplied, the projector 1 is in the stand-by state (also referred to as a “power-off state”), and lights the LED display section 28 to emit orange light, and at the same time, maintains the state in which the light source lamp 11a is put off. Then, if the operation (turning-ON operation) of the power key of the input operation section 21 is performed by the user, the control section 20 instructs the power supply circuit 27 to start to supply each section with the operation power to thereby make the projector 1 make transition to the power-ON state.

If the projector 1 makes the transition to the power-ON state, the control section 20 lights the LED display section 28 to emit green light, and at the same time, instructs the light source control section 26 to light the light source lamp 11a. As a result, the image based on the image information input to the image information input section 22 is projected from the image projection section 10. Further, the obstacle sensor 25 starts the operation for detecting the obstacle, and then outputs the detection result to the control section 20.

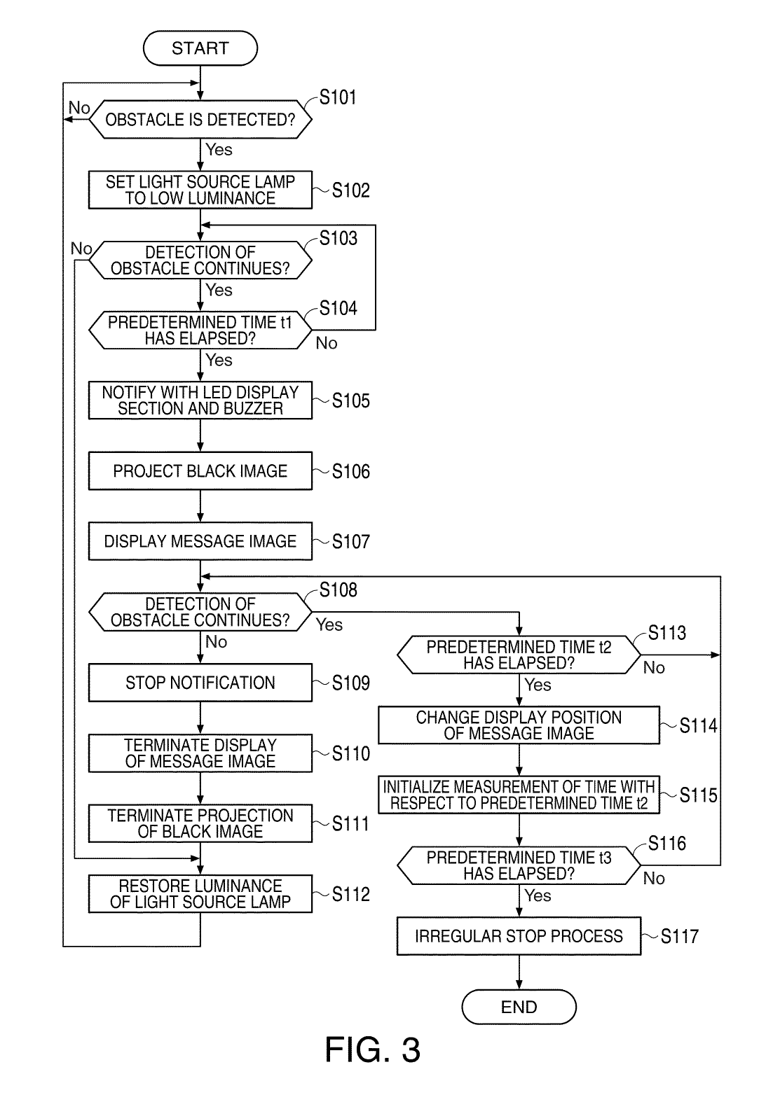

When the light source lamp 11a lights in response to the execution of the switching-ON operation by the user, the control section 20 operates with the flowchart shown in FIG. 3.

As shown in FIG. 3, in the step S101, the control section 20 determines whether or not the obstacle sensor 25 detects an obstacle in the vicinity of the projection window 3 based on the detection result of the obstacle sensor 25. Then, if an obstacle has been detected (Yes in the step S101), the process proceeds to the step S102, and if no obstacle has been detected (No in the step S101), the present step is repeated.

If the obstacle sensor 25 has detected an obstacle, the control section 20 sets (step S102) the luminance of the light source lamp 11a to the low luminance. In conjunction therewith, the luminance of the image light projected from the image projection section 10 is decreased. It should be noted that if it has already been set to the low luminance state, the state is maintained.

In the step S103, the control section 20 determines whether or not the detection of the obstacle by the obstacle sensor 25 continues based on the detection result of the obstacle sensor 25. Then, if the obstacle has been detected still, the process proceeds to the step S104, and if the obstacle has been removed, and has no longer been detected (No in the step S103), the process proceeds to the step S112.

If the obstacle has not been detected, and the process proceeds to the step S112, the control section 20 restores the luminance of the light source lamp 11a to the luminance having been set before the obstacle is detected, and the process returns to the step S101. In other words, if the luminance of the light source lamp 11a has been set to the high luminance before the obstacle is detected, the luminance is restored to the high luminance, and if it has been set to the low luminance, the state is maintained.

On the other hand, if the detection of the obstacle has continued in the step S103, and then the process proceeds to the step S104, the control section 20 determines whether or not the state of detecting the obstacle has continued for a period equal to or longer than a predetermined period t1, namely whether or not the predetermined time t1 has elapsed since the obstacle has been detected in the step S101. Then, if the predetermined time t1 has elapsed (Yes in the step S104), the process proceeds to the step S105, and if the predetermined time t1 has not yet elapsed, the process returns to the step S103. The predetermined time t1 is set to, for example, several seconds, and if the detection of the obstacle has continued for the predetermined time t1, warning (annunciation) is given to the user. In contrast, if the obstacle is removed before the predetermined time t1 has elapsed (No in the step S104), the warning is not given to the user. It should be noted that the predetermined time t1 corresponds to a first predetermined time.

If the detection of the obstacle has continued for a period equal to or longer than the predetermined time t1, and the process proceeds to the step S105, the control section 20 starts blinking of the LED display section 28 with red light, and/or making the buzzer 29 sound, namely generating the warning tone to thereby inform the user of the fact that the projector 1 is in an abnormal state.

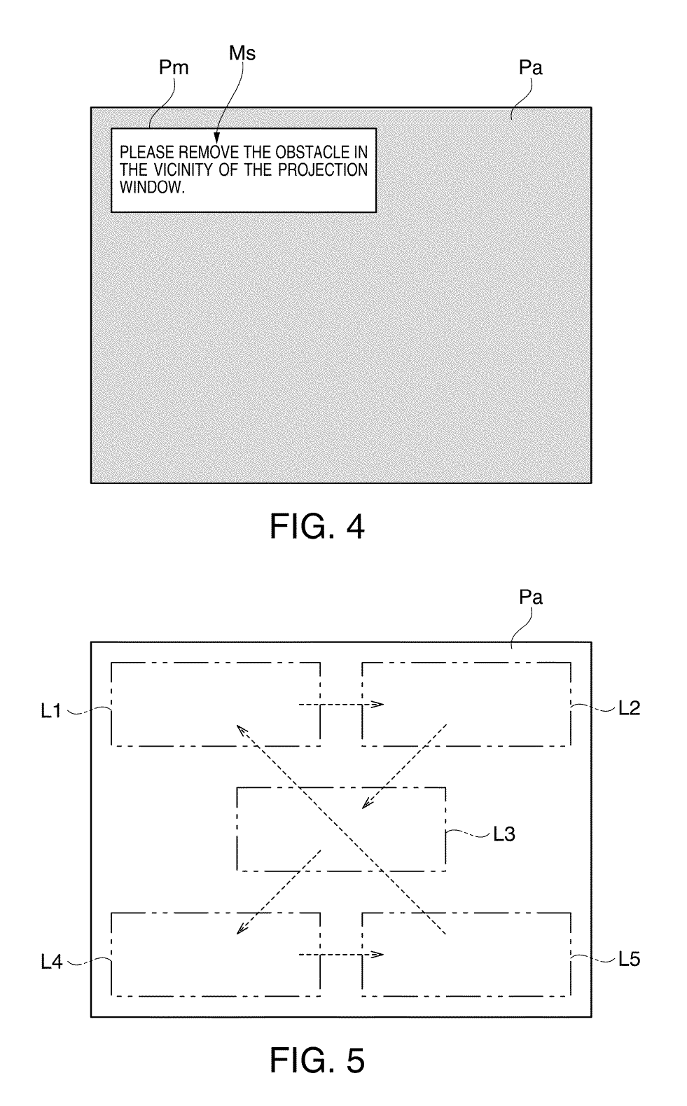

In the step S106, the control section 20 instructs the image processing section 23 to project the black image (i.e., setting the entire projection image to be projected on the screen or the like to black). Further, in the step S107, the control section 20 instructs the OSD processing section 24 to display the message image Pm (see FIG. 4) superimposed on the black image. In other wards, the control section 20 displays the message image Pm on the black background.

As shown in FIG. 4, the message image Pm is an image having a warning message Ms (e.g., “Please remove the obstacle in the vicinity of the projection window.”) for urging the user to remove the obstacle described inside a substantially rectangular area. The lateral width of the message image Pm is preferably equal to or smaller than a half of the lateral width of the image (the projection image Pa) projected by the image projection section 10, and the height of the message image Pm is preferably equal to or smaller than a third of the height (the vertical length) of the projection image Pa. In other words, the area of the message image Pm is preferably equal to or smaller than a sixth of the area of the projection image Pa. The control section 20 firstly displays the message image Pm at a position shown in FIG. 4, namely the upper left position L1 (see FIG. 5) in the projection image Pa, then changes the position of the message image Pm in accordance with the passage of time (details will be described later).

In the step S108, the control section 20 determines whether or not the detection of the obstacle by the obstacle sensor 25 continues based on the detection result of the obstacle sensor 25. Then, if the obstacle has been detected still (Yes in the step S108), the process proceeds to the step S113, and if the obstacle has been removed, and has no longer been detected (No in the step S108), the process proceeds to the step S109.

If the obstacle has not been detected and the process proceeds to the step S109, the control section 20 stops the annunciation performed by the LED display section 28 and/or the buzzer 29. Specifically, the control section 20 restores the LED display section 28 to the state of lighting with green light and/or stops the buzzer 29 from sounding.

In the step S110, the control section 20 instructs the OSD processing section 24 to terminate the superimposition display of the message image Pm. In the step S111, the control section 20 instructs the image processing section 23 to terminate the projection of the black image, and restores the image processing section 23 to the state of projecting the input image. Further, as described above, in the step S112, the control section 20 restores the luminance of the light source lamp 11a to the luminance having been set before the obstacle is detected, and the process returns to the step S101. As a result, the operation state of the projector 1 is restored to the state before the obstacle has been detected.

On the other hand, if the detection of the obstacle has continued in the step S108, and then the process proceeds to the step S113, the control section 20 displays the message image Pm at the present position, and then determines whether or not a predetermined time t2 (third predetermined time, e.g., several seconds) has elapsed since the message image Pm was displayed at the present position. Specifically, the first measurement of time with respect to the predetermined time t2 starts at the time point when the message image is displayed in the step S107. Then, if the predetermined time t2 has elapsed (Yes in the step S113), the process proceeds to the step S114, and if the predetermined time t2 has not yet elapsed, the process returns to the step S108. It should be noted that although in the present embodiment, it is arranged that the time measurement with respect to the various types of predetermined time is performed by the control section 20, it is not limited to the control section 20, but various timing devices can also be adopted.

If the predetermined time t2 has elapsed, and the process proceeds to the step S114, the control section 20 instructs the OSD processing section 24 to change the display position of the message image Pm in the projection image Pa. Then, in the step S115, the time measurement with respect to the predetermined time t2 is initialized (set to 0). Further, at the same time as the initialization of the time measurement, the control section 20 starts the time measurement with respect to the predetermined time t2 from 0.

For example, the control section 20 displays the message image Pm at the position L1 (upper left) shown in FIG. 5 in the step S107, and further, if it is determined that the predetermined time t2 has elapsed since the message image Pm was displayed at the position L1, the control section 20 changes the display position of the message image Pm to the position L2 (upper right) as shown in FIG. 5. Further, the control section 20 initializes the time measurement with respect to the predetermined time t2, and at the same time, restarts the time measurement from 0. On and after this moment, the control section 20 changes the display position of the message image Pm in the order of the position L3 (center), the position L4 (lower left), the position L5 (lower right) every time the predetermined time t2 elapses, and then, returns the display position to the position L1, and then repeats the change of the display position in the same order.

In the step S116, the control section 20 determines whether or not a predetermined time t3 (e.g., several minutes) has elapsed from the time point when the message image Pm is displayed in the step S107. In other words, the control section 20 determines whether or not the detection of the obstacle has continued for a period equal to or longer than the predetermined time t3 since the message image Pm has started to be displayed. Then, if the predetermined time t3 has elapsed (Yes in the step S116), the process proceeds to the step S117, and if the predetermined time t3 has not yet elapsed (No in the step S116), the process returns to the step S108. It should be noted that the predetermined time t3 corresponds to a second predetermined time.

If the predetermined time t3 has elapsed since the message image Pm has been displayed, and the process proceeds to the step S117, the control section 20 performs an irregular stop process to terminate the flow. As the irregular stop process, the control section 20 instructs the light source control section 26 to put off the light source lamp 11a to thereby stop the projection of the image light. Subsequently, the control section 20 instructs the power supply circuit 27 to stop the supply of the operation power to thereby make the projector 1 make a transition to the stand-by state. It should be noted that the control section 20 keeps blinking the LED display section 28 with the red light to thereby continue the annunciation of the fact that the projector 1 is in an abnormal state.

As explained hereinabove, according to the projector 1 of the present embodiment, the following advantages can be obtained.

1. According to the projector 1 of the present embodiment, since the control section 20 changes the display position of the message image Pm to be displayed in the case in which the obstacle sensor 25 detects an obstacle in accordance with the passage of time, even in the case in which the projection image Pa is partially hidden by the obstacle, the possibility of visually recognizing the message image Pm is increased by changing the display position.

2. According to the projector 1 of the present embodiment, since the message image Pm is displayed in the case in which the detection of the obstacle by the obstacle sensor continues for a period equal to or longer than the predetermined time t1 (the first predetermined time), it becomes possible to prevent the message image Pm from being displayed due to an obstacle (e.g., a hand of the user) temporarily entering the area.

3. According to the projector 1 of the present embodiment, since the light source lamp 11a is set to the low luminance to thereby decrease the luminance of the image light when the obstacle sensor 25 detects an obstacle, it becomes possible to suppress the rise in temperature of the obstacle.

4. According to the projector 1 of the present embodiment, since the light source lamp 11a is put off to thereby stop the projection of the image light in the case in which the detection of the obstacle continues for the predetermined time t3 or longer (the second predetermined time) since the message image Pm was displayed, it becomes possible to prevent the obstacle from continuing to be irradiated with the image light.

5. According to the projector 1 of the present embodiment, since the display of the message image Pm, the projection of the black image, the blinking of the LED display section 28, sounding of the buzzer 29, and the irregular stop process are not performed if the detection of the obstacle is terminated before the predetermined time t1 (the first predetermined time) has elapsed even if the obstacle sensor 25 detects the obstacle, it becomes possible to more promptly restore the projector 1 to the operation state before the trouble occurs (before detecting the obstacle).

6. According to the projector 1 of the present embodiment, since the irregular stop process is not performed if the detection of the obstacle is terminated before the predetermined time t3 (the second predetermined time) has elapsed even if the obstacle sensor 25 detects the obstacle, it becomes possible to more promptly restore the projector 1 to the operation state before the trouble occurs (before detecting the obstacle).

7. According to the projector 1 of the present embodiment, since the background of the image on which the message image Pm is displayed, namely the message image Pm is set to black, it becomes possible to suppress the irradiation of light on the obstacle while displaying the message image Pm, namely the rise in temperature of the obstacle.

8. According to the projector 1 of the present embodiment, since the control section 20 starts blinking of the LED display section 28 and sounding of the buzzer 29 in the case in which the obstacle sensor 25 detects an obstacle, it becomes possible to more reliably notify the user of the fact that the projector 1 is in an irregular state.

9. According to the projector 1 of the present embodiment, since the projection window 3 (an opening section) for guiding the image light to the outside is provided to the housing 2, and the obstacle sensor 25 detects an obstacle located in the vicinity of the projection window 3, it becomes possible to easily detect the obstacle in the case in which the projector 1 is installed so that the projection window 3 faces upward, and the obstacle is mounted on the housing 2 so as to cover a part of the projection window 3.

It should be noted that in the present embodiment, the control section 20 and the OSD processing section 24 when displaying the message image Pm in a superimposed manner in the step S107 correspond to the message display section, the control section 20 and the OSD processing section 24 when changing the display position of the message image Pm in the step S114 correspond to the display position changing section, and the control section 20 when performing the irregular stop process in the step S117 to stop the projection of the image light corresponds to the projection stop section. Further, the step S101 corresponds to the detection step, the step S102 corresponds to the luminance control step, the step S106 corresponds to the image processing step, the step S107 corresponds to the message display step, the step S114 corresponds to the display position change step, and the step S117 corresponds to the projection stop step. Further, the “warning message” can correspond to both of the warning message Ms and the message image Pm including the warning message Ms.

### Modified Examples

Further, the embodiment described above can also be modified as follows.

In the embodiment described above, it is also possible to arrange that the function (size adjustment function) for contracting the input image is provided to the image processing section 23. In the size adjustment function, an image forming area having a rectangular shape and smaller than the pixel area 12a is set in the pixel area 12a of each of the liquid crystal light valves 12R, 12G, and 12B, the input image is formed in the image forming area while being contracted, and the outside of the image forming area is set to black. Further, if the input image is contracted by the size adjustment function, it is desirable to release the contraction of the input image when displaying the message image Pm. According to this configuration, it is possible to suppress that the warning message Ms is contracted to thereby degrade the visibility. It should be noted that if the liquid crystal light valves 12R, 12G, and 12B have sufficiently high resolution, it is also possible to display the message image Pm within the image forming area.

In the embodiment described above, it is also possible to arrange that the function (a keystone correction function) of correcting the keystone distortion caused when, for example, installing the housing 2 tilted with respect to the projection surface S is provided to the image processing section 23. In the keystone correction function, the image forming area having the shape capable of canceling out the keystone distortion is set in the pixel area 12a, the input image is formed within the image forming area, and the outside of the image forming area is set to black. Further, if the keystone distortion is corrected by the keystone correction function, it is desirable to keep the corrected state when displaying the message image Pm. In this case, it is possible to suppress the phenomenon that the message image Pm is distorted to degrade the visibility. It should be noted that if the tilt of the housing 2 is not so large, it is also possible to arrange that the message image Pm is displayed in the state of releasing the keystone correction function.

Although in the embodiment described above it is arranged that the size (the area) of the message image Pm is equal to or smaller than a sixth of the projection image Pa, and the display positions of the message image Pm are five positions, namely the position L1 through the position L5, the size of the message image Pm and the number of display positions are not limited thereto. For example, if the liquid crystal light valves 12R, 12G, and 12B have high resolution, it is possible to downsize the message image Pm without substantially degrading the visibility. Further, as the message image Pm is downsized to increase the number of display positions, the possibility of making it possible to visually recognize the message image Pm is enhanced even in the case in which the projection image Pa is partially hidden by the obstacle.

Further, it is also possible to adopt a method of retrieving the image data stored in the nonvolatile memory such as a flash memory, and drawing the message image instead of using the OSD as the display method of the message image.

In the embodiment described above, it is not necessary to make the size of the message image Pm always constant, but it is possible to change the size during the process, or to gradually vary the size.

Although in the embodiment described above, the display position is sequentially changed every time the predetermined time t2 has elapsed since the message image Pm was displayed, it is also possible to arrange that the message image Pm is smoothly moved as time goes on.

Although in the embodiment described above, the display position of the message image Pm is changed every predetermined time t2, the timing at which the display position is changed can also be irregular.

Although in the embodiment described above, the display position of the message image Pm is changed with a predetermined sequence, it is also possible to change it randomly.

Although in the embodiment described above, the background of the message image Pm is set to black with the minimum pixel value, the pixel values other than the minimum value can also be adopted. Further, although the color other than black and the input image can also be set to the background, in order to suppress the irradiation of the light on the obstacle, it is desirable for the background to have a dark color.

Although in the embodiment described above, the control section 20 performs the blinking of the LED display section 28 and the sounding of the buzzer 29 in the step S105 in order to notify the user of the fact that the projector 1 is in an abnormal state, it is also possible to perform either one thereof. In conjunction therewith, in step S109, the control section 20 stops performing the one performed above.

Although in the embodiment described above, in the step S104, if the predetermined time t1 has elapsed since the obstacle was detected, the processes of the steps S105 through S107 are performed, these processes can be performed in any order. Further, although in the step S108, if the obstacle fails to be detected, the processes of the steps S109 through S111 are performed, these processes can also be performed in any order.

Although in the embodiment described above the three-panel projector 1 using the three liquid crystal light valves 12R, 12G, and 12B as the light modulation device is explained, the invention is not limited thereto. For example, it is also possible to adopt an aspect of performing the modulation into the image light with a single liquid crystal light valve having the pixels each including sub-pixels capable of respectively transmitting the R light, G light, and B light.

Although in the embodiments described above the transmissive liquid crystal light valves 12R, 12G, and 12B are used as the light modulation devices, it is also possible to use reflective light modulation devices such as reflective liquid crystal light valves. Further, it is also possible to use a micromirror array device for modulating the light emitted from the light source by controlling the emission direction of the incident light for every micromirror as a pixel.

Although in the embodiment described above, the light source device 11 is formed of the discharge light source lamp 11a, the invention can be applied to a sold-state light source such as an LED light source or a laser light source, or other light sources.

What is claimed is:

1. A projector adapted to project image light while making the image light wide-angle with a reflecting section to thereby display an image, comprising:
a detection section adapted to detect an obstacle, which blocks the image light reflected by the reflecting section;
a message display section adapted to display a warning message within the image if the detection section detects the obstacle; and
a display position change section adapted to change a display position of the warning message within the image in accordance with passage of time.

2. The projector according to claim 1, further comprising:
a luminance control section adapted to decrease a luminance of the image light in response to the detection section detecting the obstacle.

3. The projector according to claim 1, further comprising:
a housing having an opening section adapted to guide the image light reflected by the reflecting section,
wherein the detection section detects an obstacle blocking at least a part of the opening section.

4. A method of controlling a projector adapted to project image light while making the image light wide-angle with a reflecting section to thereby display an image, the method comprising:
detecting an obstacle, which blocks the image light reflected by the reflecting section;
displaying a warning message within the image if the obstacle is detected; and
changing a display position of the warning message within the image in accordance with passage of time.

5. The method of controlling a projector according to claim 4, further comprising:
displaying the warning message if the detection of the obstacle has continued for a first predetermined time.

6. The method of controlling a projector according to claim 4, further comprising:
decreasing luminance of the image light if the obstacle is detected.

7. The method of controlling a projector according to claim 5, further comprising:
decreasing luminance of the image light if the obstacle is detected.

8. The method of controlling a projector according to claim 4, further comprising:
stopping the projection of the image light if the detection of the obstacle has continued for a second predetermined time since the warning message was displayed.

9. The method of controlling a projector according to claim 5, further comprising:
stopping the projection of the image light if the detection of the obstacle has continued for a second predetermined time since the warning message was displayed.

10. The method of controlling a projector according to claim 6, further comprising:
stopping the projection of the image light if the detection of the obstacle has continued for a second predetermined time since the warning message was displayed.

11. The method of controlling a projector according to claim 7, further comprising:
stopping the projection of the image light if the detection of the obstacle has continued for a second predetermined time since the warning message was displayed.

12. The method of controlling a projector according to claim 4, further comprising:
setting the image in which the warning message is displayed to black if the obstacle is detected.

13. The method of controlling a projector according to claim 4, further comprising:
starting at least one of switching of a display state of a state indication section adapted to indicate an operation state of the projector, and generation of a warning tone if the obstacle is detected.
